(19) United States
(12) Patent Application Publication
(10) Pub. No.: US 2014/0196371 A1
(43) Pub. Date: Jul. 17, 2014

(54) CHILD SAFETY GATE WITH LOCKING DEVICE

(71) Applicant: Joran Lundh, Hong Kong (CN)

(72) Inventor: Joran Lundh, Hong Kong (CN)

(21) Appl. No.: 14/239,073

(22) PCT Filed: Aug. 23, 2012
(86) PCT No.: PCT/EP2012/066460

§ 371 Date: Feb. 14, 2014

Related U.S. Application Data
(60) Provisional application No. 61/526,465, filed on Aug. 23, 2011.

(30) Foreign Application Priority Data
Aug. 23, 2011 (SE) 1150762-1

(51) Int. Cl. E06B 9/08; E05B 17/10; E06B 11/04; E05B 41/00

(52) U.S. Cl. CPC E06B 9/08; E05B 41/00; E05B 17/10; E06B 11/04
USPC 49/13; 160/309; 160/10; 49/449; 49/414

(57) ABSTRACT

A child safety gate has a flexible barrier sheet (102) which is moveable between an open and a closed position. The gate (100) also has a locking device (110) for locking the barrier sheet (102) in the locked position. The locking device (110) includes or is connected to a locking indicator which indicates a first state corresponding to the locked state of the locking device (110) and a second state corresponding to an unlocked state of the locking device (110).

### CROSS-REFERENCE TO RELATED APPLICATIONS

This application is the US National Stage under 35 U.S.C. §371 of International App. No. PCT/EP2012/066460 having an international filing date of Aug. 23, 2012, and which in turn claims priority to U.S. App. No. 61/526,465 and Swedish App. No. 1150762-1, both of which were filed on Aug. 23, 2011.

### TECHNICAL FIELD

The present invention relates to a child safety gate of a basic structure known from WO 2010/007078, and more precisely the invention concerns a child safety gate having a locking device.

### BACKGROUND

There are several different types of child safety gates available on the market. Such child safety gates are typically used in narrow passageways, such as doorways or stairway entrances, in order to prevent children from passing through the passageways.

U.S. Pat. No. 5,690,317 discloses a control mechanism with a locking system for screen rollers, for example child safety barriers across a doorway. The control mechanism prevents the screen from pulling out by locking the roller onto which the screen is wound. Hence, a user—such as a parent—may choose to lock the roller such that it may not be opened by a non-authorized user such as a child. Further child safety gates are disclosed in WO 94/00664 and U.S. Pat. No. 7,178,792.

Although such child safety barriers provide an efficient way of preventing undesired access to certain areas or rooms, they are also subject to some disadvantages. For example, the child safety gate may not be functional if the locking mechanism has been damaged and is thus not working properly. In such cases a user, e.g. a parent, may close and lock the child safety barrier. However, if the locking device is broken the barrier may still be opened. Hence, there is a need for an improved child safety gate having an increased degree of safety.

### SUMMARY

A new child safety gate is disclosed which is improved over prior-art gates of similar type. In particular, the child safety gate has a locking device from which it is clear whether the gate is locked or not.

In one aspect, the child safety gate comprises a flexible retractable barrier sheet being moveable between an open position and a closed position, and a locking device being capable of locking the barrier sheet in the closed position. The locking device includes or is operatively connected to a locking indicator capable of indicating a first state corresponding to a locked state of the locking device, and a second state corresponding to an unlocked state of the locking device.

An advantage of the improved child safety gate is that it is immediately clear to a user if the child safety gate is locked or unlocked.

A further advantage is that the user is also notified if the locking device is working properly or not.

In an embodiment, the locking indicator is a visual indicator, a tactile indicator, a sound indicator or any combination of such indicators. One example of a locking indicator may be a protrusion which is both visual and tactile. The locking indicator protrusion may be stationary in the locking device and configured to co-operate with an associated locking member which is spring biased and movable along (i.e., relative to) the protrusion for indication purposes.

Improved child safety gates according to these embodiments provide for a versatile and efficient locking indication.

In an aspect of the safety gate, a locking device is provided for a child safety gate; said gate having a flexible barrier sheet contained in a roller unit and configured to be rolled out and detachably engaged with a holding device spaced from the roller unit. The locking device is associated with the roller unit or the holding device and comprises a locking indicator having a visual and/or tactile protrusion integrated in the locking device which thereby is capable of indicating a locked state where the locking device locks the barrier sheet and prevents movement of the same, and an unlocked state where the locking device allows movement of the barrier sheet.

By means of a locking device of this design, safe operation of the gate is achieved since it efficiently indicates to users whether the barrier sheet is in its locked or unlocked state.

A method for indicating a current state of a locking device of a child safety gate comprises the steps of:
changing the locking device from a locked state to an unlocked state, or from an unlocked state to a locked state, and
indicating the current state of the locking device upon said change.

An advantage of this inventive method is that it is immediately clear to the user whether the gate is locked or unlocked, and furthermore that the user is easily notified if the locking device is operating properly.

Advantages are achieved by using a locking indicator for indicating whether a flexible retractable barrier sheet of a child safety gate is in a locked state where pull out of the barrier sheet is prevented, or in an unlocked state where pull out of the barrier sheet is possible.

### BRIEF DESCRIPTION OF THE DRAWINGS

Embodiments of the invention will be described in the following, reference being made to the accompanying drawings which illustrate non-limiting examples of how the inventive concept can be reduced into practice.

FIG. 1 shows a partly opened child safety gate;

FIG. 2 shows the child safety gate of FIG. 1 in a closed position;

FIG. 3 is a perspective view of a locking device in a locked state;

FIG. 4 is a perspective view of the locking device of FIG. 3 in an unlocked state;

FIG. 5 is a cross-sectional view of the locking device of FIGS. 3-4 in the locked state of FIG. 3;

FIG. 6 is a cross-sectional view of the locking device of FIGS. 3-4 in the unlocked state of FIG. 4;

FIG. 7 is a cross-sectional view of a knob of the locking device of FIGS. 5-6;

FIG. 8 is a perspective view of the knob seen from below; and

FIG. 9A shows internal elements of the locking device of FIGS. 5-6.

FIGS. 9B and 9C show the locking device with a light emitter and a sound indicator, respectively.

### DETAILED DESCRIPTION OF EMBODIMENTS

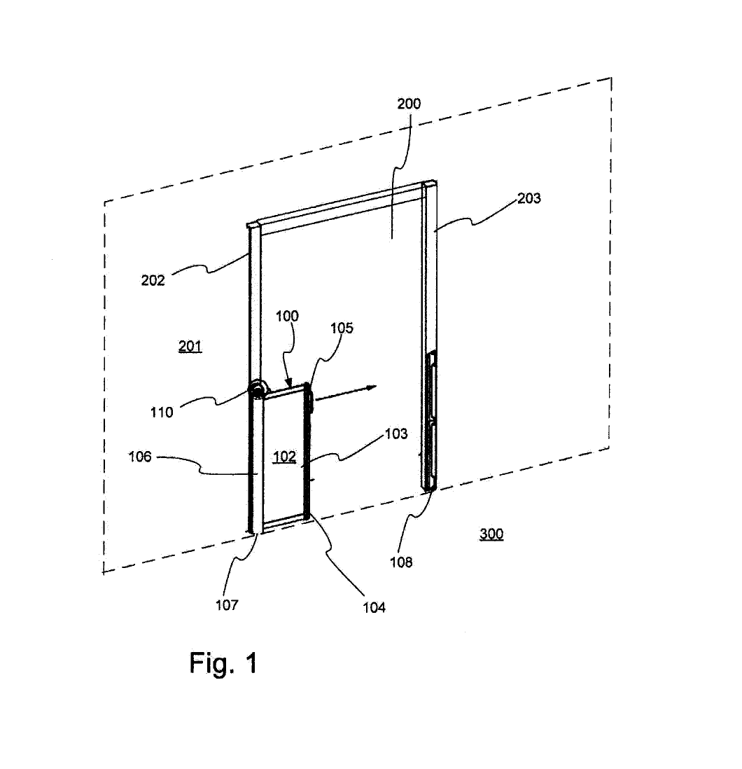

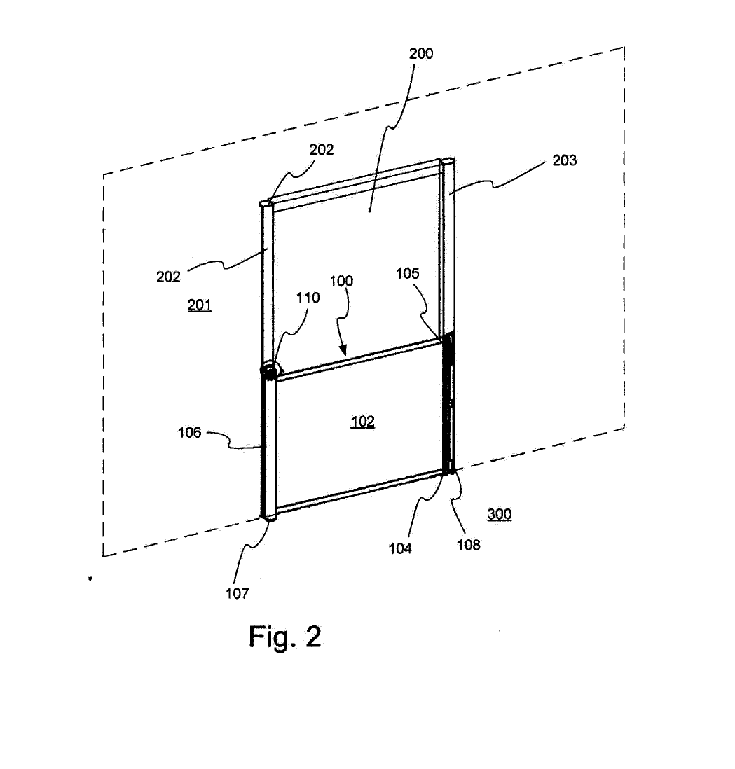

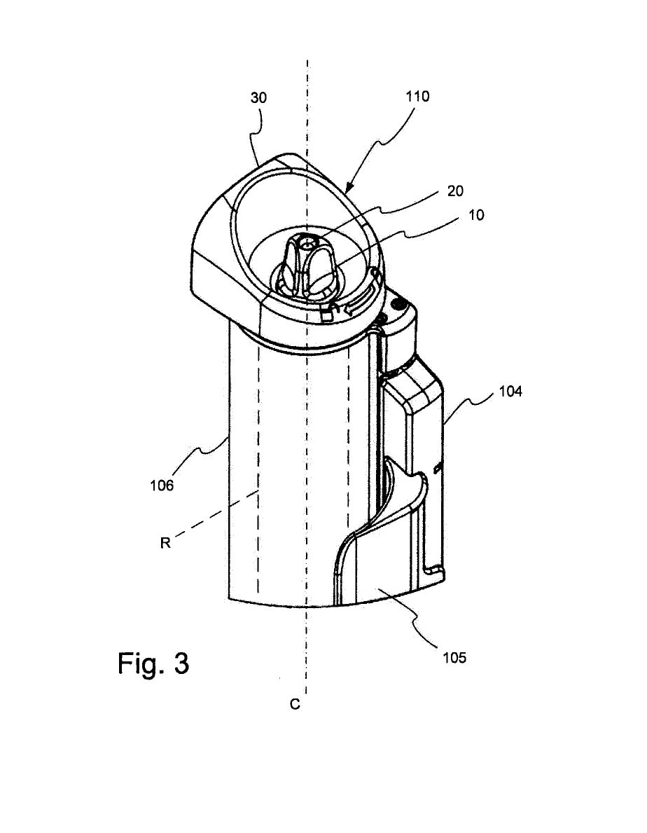

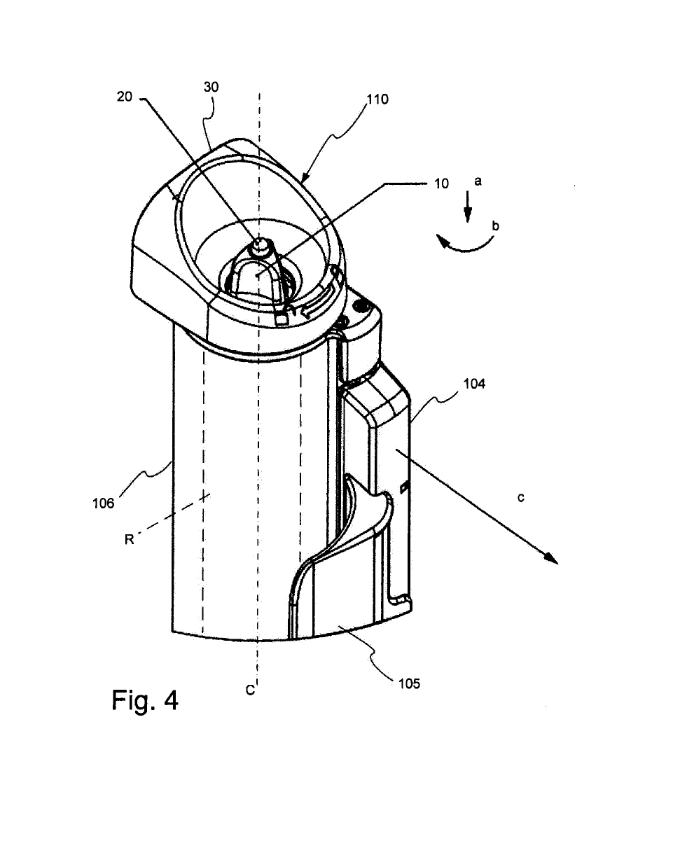

With reference to FIGS. 1-2, a child safety gate 100 is arranged in a passageway in the shape of a door opening 200 in a wall 201 above a floor 300. The door opening 200 is defined by two opposite doorposts 202, 203 forming two sides of the passageway. The child safety gate 100 has a housing 106 which is mounted to one of the doorposts 202 and which contains a flexible retractable barrier sheet 102 wound on a roller R (see FIGS. 3-4). The housing 106 has a rollback device 107 for the barrier 102, and the barrier has—at its free end—a securing means 104 for detachable engagement with a holding device 108 mounted to the opposite doorpost 203. The barrier 102 also has a handle 105 by means of which a user operates the gate 100. Hence, the safety gate arrangement includes a roller unit 106, 107 secured to one doorpost 202 and a device 108 which is fastened to or integrated in another doorpost 203 and which is adapted to hold the barrier 102 in its extracted position. The roller unit 106, 107 also has a locking device 110 to be further described below.

The barrier sheet 102 may be made of a natural or synthetic material, such as cloth or woven fabric, or any material that may be attached to and wound up onto a roller R. Hence, the barrier sheet 102 may be pulled out and unwound from the roller R to close or cover the door opening 200. The roller R is positioned within the housing 106 and the roller is—at its upper end—connected to the locking device 110, and is—at its lower end—connected to the rollback device 107. The housing 106 has a slit (not shown), through which the flexible barrier sheet 102 is pulled out and which may have predetermined dimensions for making the gate 100 more child proof.

The rollback device 107 is attached to a lower end of the housing 106 and is configured to provide a momentum for rotating the roller R for rolling back the barrier sheet 102 onto the roller R after the barrier sheet 102 has been pulled out. The locking device 110 is attached to an upper end of the housing 106, and comprises a locking means 10 and a locking indicator 20 (see FIGS. 3-4).

The securing means 104 stabilizes the outer free end 103 of the barrier sheet 102 and fits with the holding device 108 so that the securing means 104 may be engaged with the holding device 108 for preventing the barrier sheet 102 from being rolled up onto the roller R. The handle 105 is attached to the securing means 104 and may be used to easily move the securing means 104 into interlocking engagement with the holding device 108. The holding device 108 is positioned on the opposite side of the door opening 200 relative to the housing 106, so that the barrier sheet 102 may be pulled out and attached between the housing 106 and the holding device 108 for covering or closing the door opening 200.

The housing 106 and the holding device 108 may be mounted in a substantially vertical position, although other positions are possible depending on the geometry of the opening to be closed. For example, a child safety gate could be mounted inclined for covering an opening in an inclined wall, or vertically mounted for covering an opening in a vertical wall. The housing 106 and the holding device 108 are preferably mounted to the doorposts 202, 203 by means of screws (not shown), but could as well be attached using special fittings, nails, adhesive or strong magnets. Preferably, the housing 106 is tubular and consists of an elongate, extruded aluminum profile with open ends and a length adapted to the length of the roller R. However, the housing 106 could also be made of plastics or some other suitable material.

FIG. 2 shows the child safety gate 100 of FIG. 1 in a completely closed position. To close the safety gate 100 the barrier sheet 102 is extracted to a length sufficient to cover the door opening 202. The securing means 104 in the outer free end 103 of the barrier sheet 102 is then engaged with the holding device 108 mounted to the other side of the door opening 200 opposite the housing 106.

For extracting the barrier sheet 102 from the housing 106, the locking device 110 may first be shifted into its unlocked state and then extracted from the housing 106. When attaching the securing means 104 to the holding device 108, the barrier sheet 102 may be extracted to a small extent past the holding device 108 and then retracted to the holding device 108. When the barrier sheet 102 moves in the opposite direction compared to the direction when extracting the barrier sheet 102 (i.e., the retracting direction), the locking device 110 automatically switches back to its original locked state, which means that the barrier sheet 102 no longer may be extracted further before shifting the state of the locking device 110 again. The extended length passing the holding device 108 for activating the locking device 110 should preferably be at least about 4 mm.

When opening the child safety gate 100, the locking device 110 may first be unlocked before the user may extract the securing means 104 from the holding device 108 and then retract the barrier sheet 102 into the housing 106.

FIG. 3 shows a locking device 110 according to an embodiment having a locking means or member 10, a locking indicator 20 and a protective top or cover 30. The locking means 10 is arranged within the protective cover 30 and is movable along a longitudinal axis C. Furthermore, the locking means 10 is rotatable around the longitudinal axis C.

The locking means 10 of the locking device 110 has at least a locked state and an unlocked state where FIG. 3 shows the locking device in the locked state. The locking means 10 is configured to—in its locked state—prevent further extraction of the barrier sheet 102 attached to the roller R. Also, the locking means 10 is configured to—in its unlocked state—allow extraction of the barrier sheet 102. Preferably, the locking device 110 always allows retraction of the barrier sheet 102 although the locking device 110 may be configured to only allow extraction of the barrier sheet 102 upon activation of a mechanism, so that children are prevented from playing with the barrier sheet 102 by extracting it from the housing 106. The locking means 10 is configured to allow release thereof in order to bring the locking device 110 into its unlocked state.

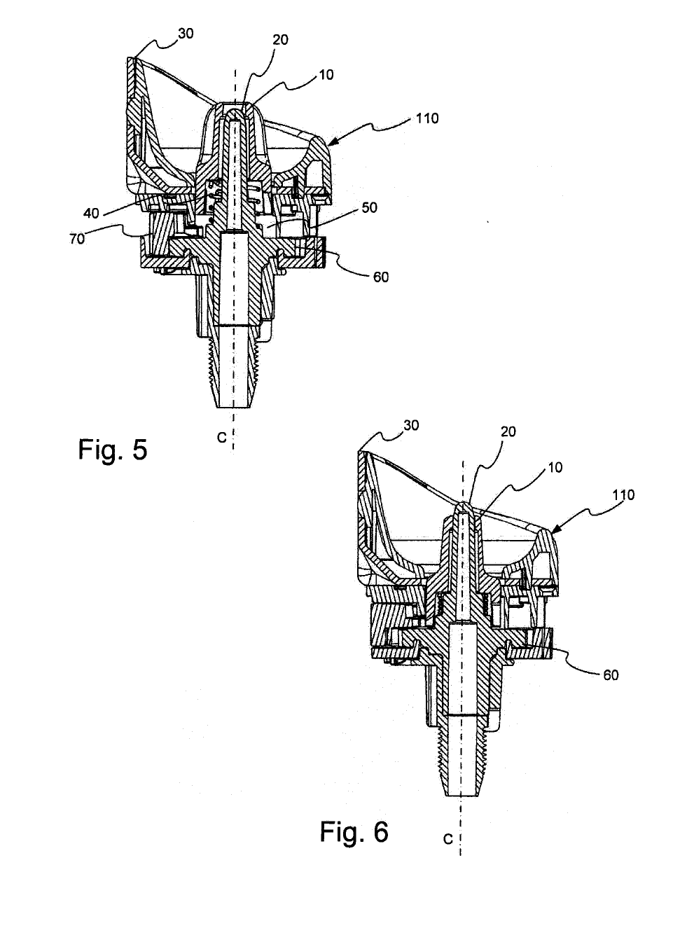

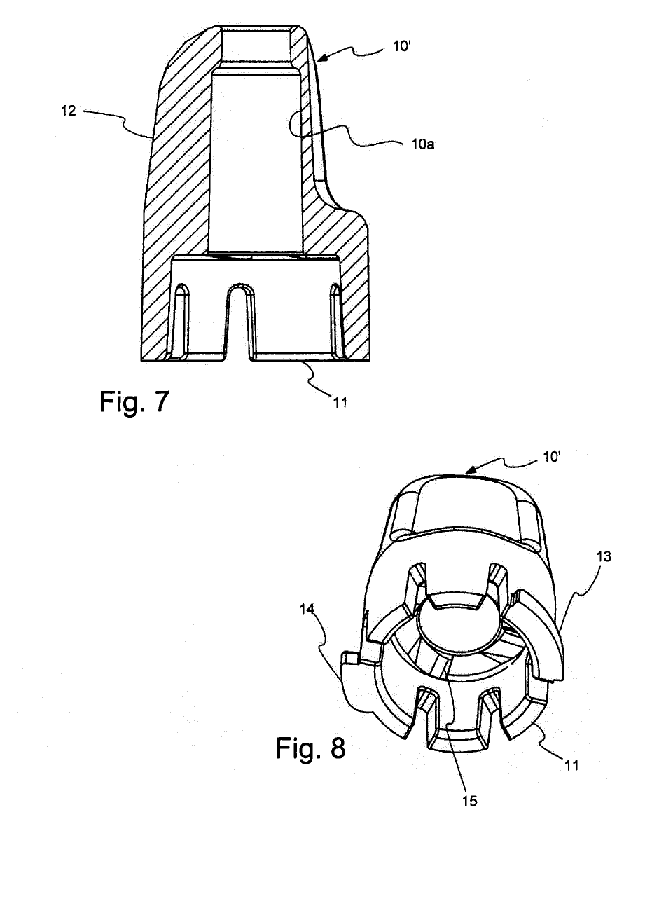

The locking indicator 20 of the locking device 110 is arranged stationary within and connected (or operatively connected) to the locking means 10, and it is configured to notify the user when the locking device 110 is in its locked or unlocked state. FIGS. 3-6 show a locking indicator 20 in the shape of a protrusion which is visible when the locking device 110 is in its unlocked state (FIG. 6) and the locking means 10 partly covers the locking protrusion 20, and invisible (from the side) when the locking device 110 is in its locked state (FIG. 5).

FIG. 4 shows the locking device 110 of FIG. 3 in a state where the locking indicator 20 protrudes upwards and is visible. In this embodiment, the visible locking indicator 20 is referred to an unlocked locking device 110. To unlock the locking device 110 and extract the barrier sheet 102 the user may follow three steps shown in FIG. 4 (see arrows):
a) press down the locking means 10 along the longitudinal axis C,
b) rotate the locking means 10 around the longitudinal axis C,
c) extract the barrier sheet 102 by pulling the handle 105.

Preferably, the user may press down the locking means 10 about 6 mm and then rotate the locking means 10 about 60° for unlocking the locking device 110.

In this embodiment, the locking indicator 20 will become visible when pressing down the locking means 10. Another embodiment of the locking indicator 20 (not shown) may be that the locking indicator 20 is visible when the locking device 110 is in its locked state and invisible when the locking device 110 is in its unlocked state. In alternative embodiments (not shown), the locking member may be stationary and the locking indicator movable between two positions for indication purposes.

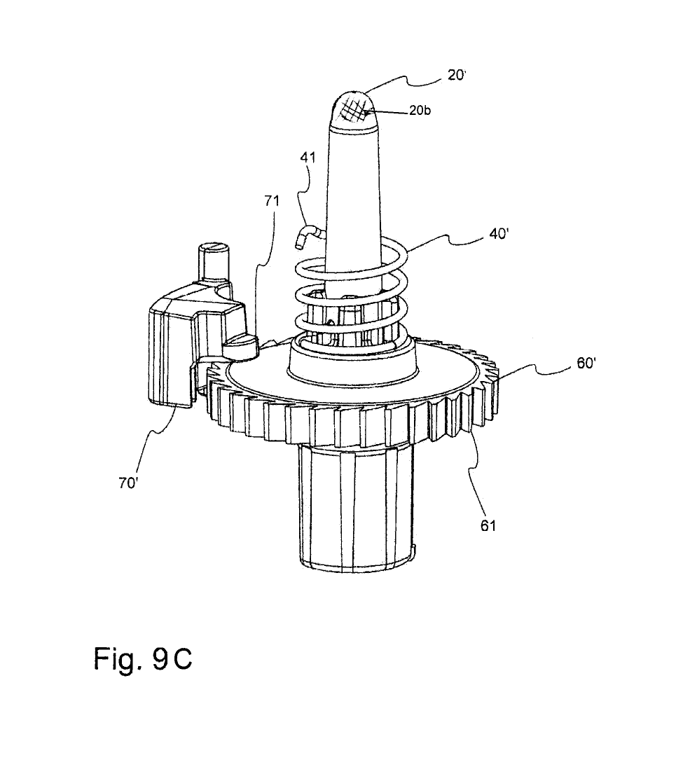

The locking indicator 20 may appear in many other embodiments such as a visual indicator, a tactile indicator, a sound indicator or any combination of such indicators (not shown). For example the locking indicator 20 may be a light emitter 20a (FIG. 9B) which may be switched on and emit light when the locking device 110 is in its locked state or vise versa. Another example is that the light emitter may emit lights of different colors depending on the state of the locking device 110. Yet in another embodiment, the locking indicator 20 may be a sound indicator 20b (FIG. 9C). The sound indicator may be configured to generate an audio signal for notifying a user if the locking device 110 is locked or unlocked. Another example of the sound indicator may be that the indicator generates an audio signal when a user is trying to open the locked child safety gate 100 or when a user is trying to close the barrier sheet 102 and the locking device 110 switches to its locked state.

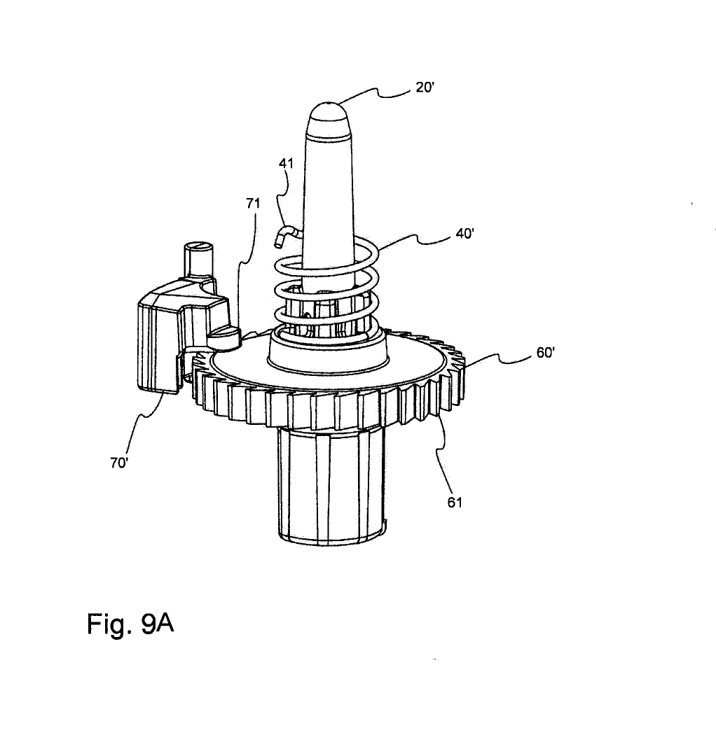

FIG. 5 shows a cross-section of the locking device 110 comprising the locking means or member 10, the locking indicator 20, a spring 40 and a gap 50. In this embodiment, the locking indicator 20 is the same as in FIGS. 3 and 4, in the shape of a protrusion which is arranged stationary within the locking means 10 of the locking device 110 and where the locking means 10 is spring biased by a spring 40. The locking means 10 has an internal bore 10a (FIG. 7) in which the locking indicator 20 is arranged.

The locking indicator 20 and the locking means 10 are preferably made of a plastic material, but other materials are feasible, for instance wood or metal. Preferably, the upper end portion of the locking indicator 20 which extends beyond the upper end of the locking means 10 has a color different from the adjacent portion of the locking means 10. Thereby the unlocked position is clearly shown to a user of the child safety gate 100.

FIG. 6 shows a cross-section of the locking device 110 of FIG. 5 in another state, i.e. when the locking device 110 is unlocked. In a preferred embodiment, the locking device 110 includes a toothed gear 60 which is connected to the roller R. The toothed gear 60 is rotatable around the vertical axis C and fixedly connected to the roller R such that the roller R and the toothed gear 60 rotate together during operation. The toothed gear 60 is further engageable with a pivoting member 70 which, upon engagement with the toothed gear 60, prevents the gear 60 from rotating. For unlocking the pivoting member 70 is disengaged from the toothed gear 60 such that the gear 60 and roller R are allowed to rotate. The pivoting member 70 is further operated by means of a cam of the locking means 10, such that the cam urges the pivoting member 70 to pivot and thus release the toothed gear 60. Upon this, the flexible barrier sheet 102 is able to be unwound from the roller R as the roller R is free to rotate.

The pivoting member 70 is preferably spring biased, such that it may return automatically to its idle position, i.e. in which it engages with the toothed gear 60. This may be done when the rotating direction of the roller R or toothed gear 60 is changed. For example, if the locking device 110 is unlocked, a user may pull the barrier sheet 102 until it has reached its desired length. After the securing means 104 has been engaged with the holding device 108 there will be a small return rotation of the roller R until the flexible barrier sheet 102 is stretched. This return movement will cause the pivoting member 70 to return and thus engage with the toothed gear 60 such that the locking device 110 is locked.

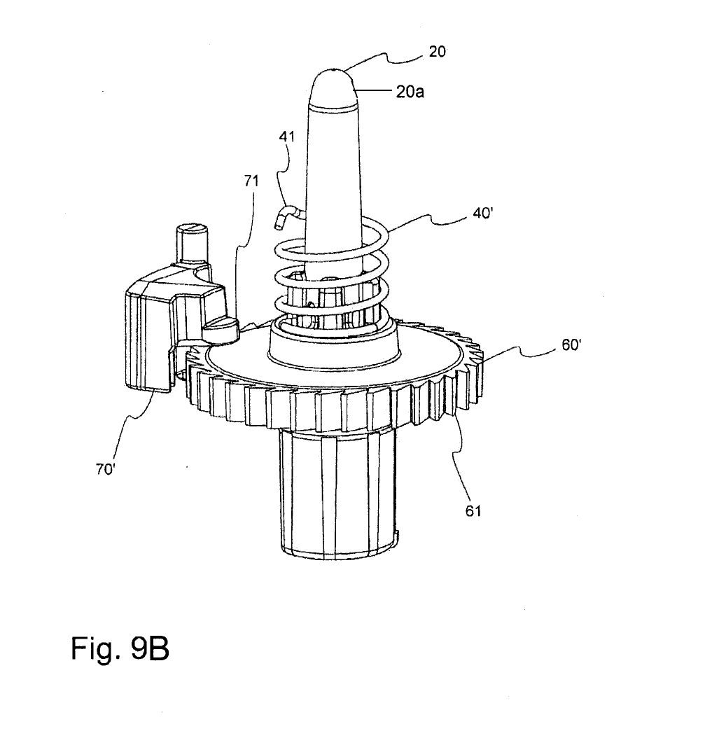

FIGS. 7-9 show a locking device 110 according to an embodiment where FIG. 7 shows a cross-section of a locking means or member in the shape of a knob 10′, FIG. 8 is a perspective view from below of the locking knob 10′ and FIG. 9 is a perspective view of an assembly comprising a locking indicator 20′, a spring 40′, a toothed gear 60′ and a pivoting member 70′.

The locking knob 10′ shown in FIGS. 7-8 comprises a base portion 11, an upper portion 12 and an internal bore 10a for receiving a locking indicator 20′. The base portion 11 further includes a first flange 13 and a second flange 14 both located at the lower end of the base portion 11. The first flange 13 is arranged as a guiding flange so that the locking knob 10′ does not tilt. The length of the first flange 13 may correspond to the length of which the locking knob 10′ may be rotated. The second flange 14 is arranged to push on a third flange (shown in FIG. 9) on the pivoting member 70′ so that the pivoting member 70′ is released from the toothed gear 60′ enabling a user to pull out the flexible retractable barrier sheet 102 of the child safety gate 100. At the bottom of the upper portion 12 of the locking knob 10′ there is at least one internal wedge shaped element 15 which allows the locking knob 10′ to be rotated in one direction, e.g. in a clockwise direction, and prevent it from being rotated in the opposite direction, e.g. in a counter-clockwise direction.

The spring 40′ shown in FIG. 9 has a curved upper end 41 which interacts with the wedge shaped element 15 so that when the locking knob 10′ is being rotated in one direction, e.g. the clockwise direction, the spring 40′ may not affect the locking knob 10′. As soon as the knob 10′ starts to rotate in the opposite direction, the curved upper end 41 of the spring 40′ is pressed towards the flat side portion of the wedge shaped element 15 so that the locking knob 10′ is pushed up, to its locked position (shown in FIG. 5).

FIG. 9 also shows—with the knob 10′ detached—the locking indicator 20′ enclosed by the spring 40′, the toothed gear 60′ and the pivoting member 70′. Here, the pivoting member 70′ is in its locked position in engagement with one or more teeth 61 of the toothed gear 60′. As has been described above, the pivoting member 70′ comprises a third flange 71 which may interact with the second flange 14 of the locking means 10′.

To unlock the locking device 110 the user must press down the locking means 10′ and rotate it, e.g. clockwise, so that its second flange 14 pushes on the third flange 71 and thereby disconnects the pivoting member 70′ from the toothed gear 60′. The user may then extract the flexible retractable barrier sheet 102 (see FIGS. 1-2) to close or cover the door opening 200. When the user retracts the barrier sheet 102 and attaches it to a holding device 108, the second flange 14 is rotated away from the third flange 71 so that the pivoting member 70′ again comes into contact with and engages the toothed gear 60′ and locks the locking device 110, and the locking knob 10′ is by means of the spring 40′ pushed into its locked position.

As mentioned above, various combinations of indicators can be used. In an embodiment (not shown), the top of the locking indicator protrusion 20 is provided with a light emitter indicating whether the locking device 110 is in its locked or unlocked state.

It should be appreciated that even though numerous characteristics and advantages of the present invention have been set forth in the foregoing description, together with details of the structure and function of the invention, the description is illustrative only, and changes may be made in detail, especially in matters of shape, size, and arrangement of parts within the scope of the invention to the full extent indicated by the appended claims.

1. A child safety gate for a passageway, such as a door opening, comprising:
a flexible retractable barrier sheet which is wound on a roller mountable to one side of the passageway, said barrier sheet being moveable between a first position in which the barrier sheet is retracted and the passageway is open, and a second position in which the barrier sheet is extended and has an outer free end attached to an opposite side of the passageway which is then closed by the barrier sheet; and
a locking device which is configured to lock the barrier sheet in the extended position in which the passageway is closed;
wherein the locking device includes or is operatively connected to a locking indicator capable of indicating if the locking device is in a first state corresponding to a locked state of the locking device or a second state corresponding to an unlocked state of the locking device.

2. The child safety gate according to claim 1, wherein the locking indicator forms a part of the locking device.

3. The child safety gate according to claim 1, wherein the state of the locking device automatically switches between its locked and unlocked states when a user is locking or unlocking the barrier sheet.

4. The child safety gate according to claim 1, wherein the locking indicator is a visual indicator, a tactile indicator or a sound indicator or any combination of such indicators.

5. The child safety gate according to claim 4, wherein the locking indicator comprises a visual and/or tactile a protrusion integrated in the locking device.

6. The child safety gate according to claim 5, wherein the locking indicator protrusion is stationary in the locking device and wherein an associated locking member is spring biased and movable relative to the protrusion.

7. The child safety gate according to claim 4, wherein the locking indicator comprises a light emitter which switches on or off when the locking device is locked or unlocked.

8. The child safety gate according to claim 4, wherein the locking indicator comprises a light emitter which switches color when the locking device is locked or unlocked.

9. The child safety gate according to claim 4, wherein the locking indicator comprises means capable of generating an audio signal for notifying a user if the locking device is locked or unlocked.

10. The child safety gate according to claim 4, wherein the locking indicator comprises means capable of generating an audio signal when the locking device is locked and a user is trying to open the child safety gate.

11. A locking device for a child safety gate, said gate having a flexible barrier sheet wound on a roller and configured to be rolled out and detachably engaged with a holding device spaced from the roller, said locking device being associated with the roller or the holding device, wherein the locking device comprises a locking indicator having a visual and/or tactile protrusion integrated in the locking device, said locking indicator indicating a locked state where the locking device locks the barrier sheet and prevents movement of the barrier sheet, and an unlocked state where the locking device allows movement of the barrier sheet.

12. The locking device according to claim 11, wherein the locking indicator protrusion is stationary and associated with a spring biased locking member which is movable relative to the protrusion.

13. (canceled)

14. (canceled)

15. A child safety gate comprising a flexible retractable barrier sheet being moveable between an open and a closed position, and a locking device being capable of locking the barrier sheet in the closed position, wherein said locking device includes or is operatively connected to a locking indicator capable of indicating a first state corresponding to a locked state of the locking device, and a second state corresponding to an unlocked state of the locking device.

16. A child safety gate for a passageway, such as a door opening, comprising:
a flexible retractable barrier sheet which is wound on a roller, said barrier sheet being moveable between a first position in which the barrier sheet is retracted, and a second position in which the barrier sheet is extended; and
a locking device which is configured to lock the barrier sheet in the extended position in which the passageway is closed;
wherein the locking device includes or is operatively connected to a locking indicator capable of indicating if the locking device is in a first state corresponding to a locked state of the locking device or a second state corresponding to an unlocked state of the locking device.
